(19) United States
(12) Patent Application Publication
(10) Pub. No.: US 2010/0186210 A1
(43) Pub. Date: Jul. 29, 2010

(54) METHOD FOR IN SITU MACHINING OF A LARGE DIMENSION PART WITH A PARALLEL ARCHITECTURE MACHINE

(75) Inventor: François Wildenberg, Contrexeville (FR)

Correspondence Address: EGBERT LAW OFFICES, 412 MAIN STREET, 7TH FLOOR, HOUSTON, TX, 77002, US

(73) Assignee: CMW CONSTRUCTION MECANIQUES DES VOSGES MARION, Rozieres Sur Mouzon (FR)

(21) Appl. No.: 12/664,825

(22) PCT Filed: Jun. 13, 2008
(86) PCT No.: PCT/FR2008/051060

§ 371 Date: Dec. 15, 2009

(30) Foreign Application Priority Data
Jun. 15, 2007 (FR) 0755773

(51) Int. Cl. B23Q 17/22

(52) U.S. Cl. 29/407.05

(57) ABSTRACT

The present invention relates to a method for working a piece with a machine called a parallel-architecture machine of the type comprising a movable tool-holder table connected to a fixed table by a plurality of legs, the machine being programmed to carry out theoretical cycles of the tools, characterized in that: the fixed table (4) of the machine (1) is fixed relative to a zone of the piece to be worked; measurements are taken of the relative position between a first entity specific to the machine and a second entity specific to the piece; from the measurements previously acquired, the exact position is deduced, in coordinates and in inclination, of the first entity in a frame of reference; the preprogrammed theoretical cycles of the tool or tools are modified according to the exact relative position of the two entities calculated in the previous step.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to anew method for working apiece with a parallel-architecture machine. The working of a piece is, for example and not limitingly, a machining, a milling, a polishing, a welding, a hammering, etc.

2. Description of Related Art Including Information Disclosed Under 37 CFR 1.97 and 37 CFR 1.98.

A parallel-architecture machine is, for example, a hexapod of the subject of several patents of the applicant. Such a machine comprises mainly a fixed table and a movable table which supports the tool or tools used to carry out the work or jobs listed above. The fixed table of the machine is connected to the movable table by a set of legs (or arms) for example six in the case of a hexapod, and the movable table is moved relative to the fixed table in order to carry out, in its volume of work, the jobs desired or in order to carry out certain measurements of the piece.

The object of the present invention is to machine or to work on site pieces of large dimensions with a parallel-architecture machine.

The known machines that work on site or that are fixed to the piece to be machined do not make it possible to carry out either high-speed machinings (HSM), or to work in five simultaneous axes, or to carry out computerized warping, or to combine these jobs together. The method according to the invention is intended to solve this problem of the prior art.

### BRIEF SUMMARY OF THE INVENTION

The problem is solved by the invention which includes a method for working a piece with a machine called a parallel-architecture machine of the type comprising a movable tool-holder table connected to a fixed table by a plurality of legs, the machine being programmed to carry out theoretical cycles of the tools, characterized by the following.

The fixed table of the machine is fixed relative to a zone of the piece to be worked.

Measurements are taken of the relative position between a first entity specific to the machine, which is either the machine itself or the support of the machine, and a second entity specific to the piece which is either the piece or a tool optionally fixed to the piece.

From the measurements previously acquired, the exact position is deduced, in coordinates and in inclination, of the first entity in a frame of reference.

The preprogrammed theoretical cycles of the tool or tools are modified according to the exact relative position of the two entities calculated in the previous step.

In particular, the solution which consists in directly or indirectly fixing the machine to the piece (1) is not known in the prior art.

A better understanding of the invention will be obtained on reading the following description given with reference to the following appended drawing.

### BRIEF DESCRIPTION OF THE SEVERAL VIEWS OF THE DRAWINGS

FIG. 1 shows a top view of a parallel-architecture machine fixed to a support positioned close to a piece to be worked, in this instance a large-dimension tank.

FIG. 2 shows a side view of a parallel-architecture machine fixed to a support positioned close to a piece to be worked, in this instance a large-dimension tank.

FIG. 3 shows a front view, side view and top view of a parallel-architecture machine fixed to a support, itself fixed approximately to a piece to be worked, in this instance for example a large-dimension tank.

FIG. 4 shows a side view of a parallel-architecture machine fixed to a support, itself fixed approximately to a piece to be worked, in this instance for example a large-dimension tank.

FIG. 5 shows a top view of a parallel-architecture machine fixed to a support, itself fixed approximately to a piece to be worked, in this instance for example large-dimension tank.

FIG. 6 shows front view of a parallel-architecture machine fixed to a table that can be operated with specific movements.

FIG. 7 shows a side view of a parallel-architecture machine fixed to a table that can be operated with specific movements.

FIG. 8 shows a top view of a parallel-architecture machine fixed to a table that can be operated with specific movements.

### DETAILED DESCRIPTION OF THE INVENTION

For the rest of the description, “machine” (1) will designate a parallel-architecture machine as defined above, for example a hexapod and comprising a fixed table (4), a movable table (5), joined together by a plurality of legs (6).

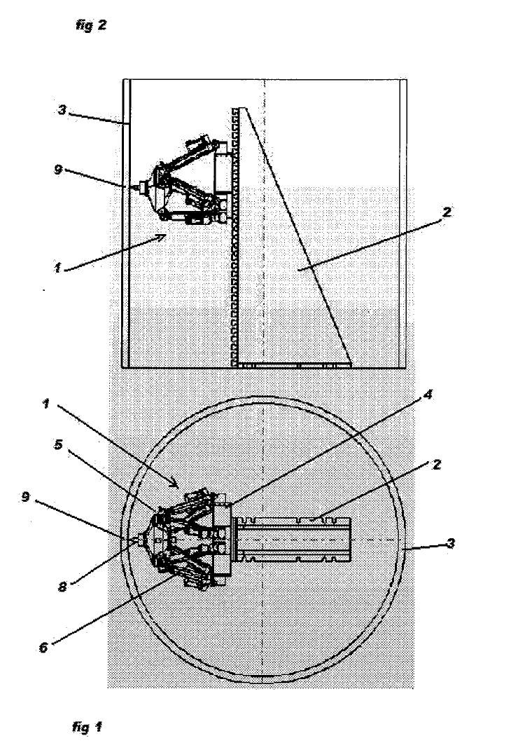

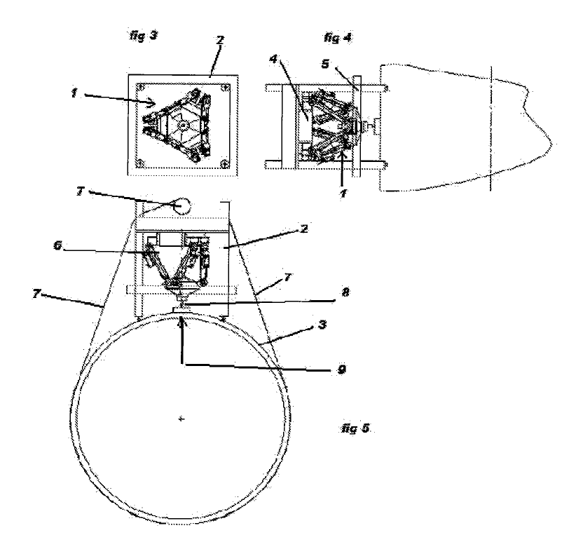

The first step of the method involves approximately fixing the fixed table (4) of the machine (1), either to a support (2) (for example an angle bracket in FIGS. 1 and 2) placed close to the piece (3) to be worked, or directly or indirectly to the piece (3). As an example of the latter fixing type, FIGS. 3 to 5 show a machine (1) fixed to a support (2) itself fixed or attached approximately to the piece by means of a fixing system (7).

In this starting position, the tool (8) (or the tools) supported by the machine is then positioned approximately relative to the zone (9) of the piece that it is to work. The following steps of the method will have to correct this machine/piece relative positioning, but there is a problem to solve associated with two incompatible constraints: the first being that it is not possible either to move the fixed table (4) or to move the piece (3) which is for example a large-dimension tank, an aircraft wing, etc.; and the second being that it is mandatory to work on site and that it becomes mandatory to move the machine.

The method according to the invention involves solving this problem and in correcting this positioning while moving the machine toward or on the piece.

The second step of the method involves taking measurements of the relative position between two entities, a first entity being the machine (1) or the support (2) of the machine, the second entity being the piece (3) or a tool optionally fixed to the piece.

There are three possibilities for measuring the relative position between the two entities. First, either with external measurement means not shown, for example: laser tracker, electronic spirit level, photogrammetry, etc. Second, by moving the movable table (5) of the first entity in front of the second entity and by measuring, during the movement, the distance or distances between the movable table (5) and the second entity. Or third, by combining these two measurement methods.

In a next step of the method, a computer software program deduces from the measurements previously acquired by one or other measurement method the exact position taking account of the tolerances imposed, in coordinates or in inclination, of the first entity and preferably of the fixed table of the machine in a frame of reference, for example a predetermined frame of reference with three axes Ox, Oy, Oz, which is either a frame of reference of the piece or a frame of reference linked to the latter. This step of measuring the position of the fixed table is not known in the prior art which knows only methods of measurement relative to the tool.

In a last step of the method, the preprogrammed theoretical cycles for the tool or tools are modified according to the relative position of the two entities which has been calculated in the previous step and in particular to the exact positioning of the fixed table, taking account of the tolerances imposed or required by the job to be done.

More particularly, based on the above results, the software calculates the real position of the fixed table relative to the piece and establishes a transfer matrix making it possible to modify in consequence the theoretical cycles of the tools.

The method according to the invention applies both to a machine supporting a single tool or supporting several tools, the latter being able to be fixed relative to the table that supports them, or operated in a specific movement. In this case the table is fitted with a movement unit that can, for example and not limitingly, be an electric spindle for carrying out milling, a system with a cylinder allowing an alternating movement of the tool for the purpose of carrying out hammering, or any other type of unit for moving a tool.

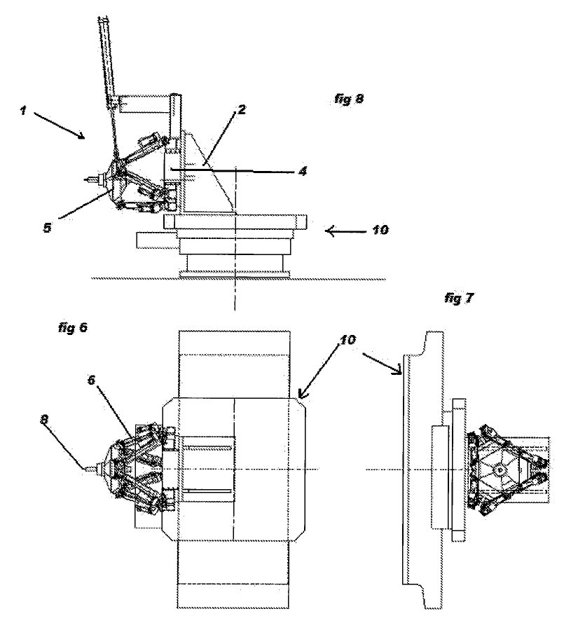

Moreover, the support (2) may be fixed or movable from one working location to the other, it may also be operated in a specific and autonomous movement. As an example, FIGS. 6 to 8 show a machine (1) fixed by its support (2) to a table (10) fitted with crossed movement means and/or rotation means.

The performance and advantages of the method according to the invention are non-limitingly achieved individually or in combination:

A possibility of extremely varied tools.

As standard, a machining electric spindle of 40 kW at 30,000 rpm is for example proposed.

As an option, the machine may be fitted with more varied tools. It therefore becomes a robot of great precision and very great rigidity. Specifically, the rigidity in the axis Oz may be greater than 700 Newtons per micron.

Possibility of machining at high speed (HSM)

The forces on the piece are very slight. Similarly the forces on the supports are very slight. Consequently, it is easy to find a support suitable for each particular case. The piece does not need to be heavily anchored.

Since the forces are weak, the residual stresses are weak, so the piece deforms very little and its service life is longer.

Example of application: the wing of an aircraft is placed on a dolly, the assembly being immobilized with two straps (normally used by truck drivers) stud-driven into the ground. The machine is fixed to an angle bracket. This is sufficient for carrying out the machining of the parting line between the wing and the cockpit. On the same principle, it is possible to machine the parting line on the cockpit.

If necessary (in the event of repairs), very thin machining thicknesses are taken. This replaces regrinding. It is also possible to take machining thicknesses that are very large with great removals of chips.

It is possible to machine materials that are reputed to be difficult (stainless steel, Inconel, titanium, treated steels, etc.).

Therefore, for example, in HSM it is possible to mill materials up to 65 HRC. This replaces regrinding.

Therefore the user machines the hardest materials as well as the softest (composites, light alloys).

A small-diameter tool is sufficient. Therefore with a tool with a 20 mm diameter, the chip output can be very great. It is equivalent to that with a large diameter consuming 40 kW.

Very simple control of the machine.

The programs are written very simply based on any computer-aided manufacture without the need for a specific post-processor.

Truing up, corrections according to temperature, tool corrections, etc., are simple functions requiring no training A truing module can be incorporated into the machine control software; it recalculates all the cycles of the tool and makes all the corrections in inclinations (roll, pitch, yaw) and all the corrections in coordinates (x, y, z).

Autonomy, lightness, small space requirement of the machine allowing it to be moved.

Use of simple, external or internal supports or use without support, which is of value for large-dimension pieces.

It is specified here that, in the description, the terms “approximate” or “approximately” mean “without concern for accuracy” from which it results that the tool, at the time of initial fixing of the machine, is not in the theoretical working position that it should have; it may have differences of coordinates and/or of inclination relative to this theoretical position that are greater than the required tolerances. The method of the invention makes it possible to remove or correct these differences as a function of said tolerances. According to any evidence at the time of initial fixing of the machine, the working zone (9) must be in the working volume of the machine.

It is also specified that the theoretical cycles of the tools and the measurements acquired by the method may be calculated in one and the same frame of reference.

I claim:

1. A method for working a piece with a machine called a parallel-architecture machine of the type comprising a movable tool-holder table connected to a fixed table by a plurality of legs, the machine being programmed to carry out theoretical cycles of the tools, characterized in that:
the fixed table (4) of the machine (1) is fixed relative to a zone of the piece to be worked,
measurements are taken of the relative position between a first entity specific to the machine and a second entity specific to the piece,
from the measurements previously acquired, the exact position is deduced, in coordinates and in inclination, of the first entity in a frame of reference,
the preprogrammed theoretical cycles of the tool or tools are modified according to the exact relative position of the two entities calculated in the previous step.

2. The method as claimed in claim 1, characterized in that the first entity is the machine itself.

3. The method as claimed in claim 2, characterized in that the first entity is the support of the machine.

4. The method as claimed in one of claims 1 to 3, characterized in that the second entity is the piece itself.

5. The method as claimed in one of claims 1 to 3, characterized in that the second entity is a tool fixed to the piece.

6. The method as claimed in claim 1, characterized in that more particularly the position of a fixed table of the machine is deduced.

7. The method as claimed in one of claims 1 to 6, characterized in that the relative position between the two entities is measured with external measurement means.

8. The method as claimed in one of claims 1 to 6, characterized in that the relative position between the two entities is measured by moving the movable table (5) of the first entity in front of the second entity and, during the movement, the distance or distances between the movable table (5) and the second entity is/are measured.

9. The method as claimed in claims 7 and 8, characterized in that the two measurement methods are combined.

10. The method as claimed in one of claims 1 to 9, characterized in that the machine is fixed directly or indirectly to the piece.

11. The method as claimed in claim 10, characterized in that the machine is fixed to the piece via a fixed support.

12. The method as claimed in claim 10, characterized in that the machine is fixed to the piece via a movable support.

13. The method as claimed in claim 12, characterized in that the support (2) is operated in a specific movement.
